(19) United States
(12) Patent Application Publication
(10) Pub. No.: US 2026/0101322 A1
(43) Pub. Date: Apr. 9, 2026

(54) Methods And Apparatus For Bandwidth Part Configuration In Mobile Communications

(71) Applicant: MediaTek Inc., Hsinchu City (TW)

(72) Inventors: Yi-Ju Liao, Hsinchu City (TW); Pei-Kai Liao, Hsinchu City (TW); Chi-Hsuan Hsieh, Hsinchu City (TW)

(73) Assignee: MediaTek Inc., Hsinchu City (TW)

(21) Appl. No.: 19/338,881

(22) Filed: Sep. 24, 2025

Related U.S. Application Data
(60) Provisional application No. 63/704,075, filed on Oct. 7, 2024.

(51) Int. Cl. H04W 72/0453

(52) U.S. Cl. CPC H04W 72/0453

(57) ABSTRACT

Various solutions for lean bandwidth part (BWP) radio resource control (RRC) configuration with respect to an apparatus are described. An apparatus may receive a configuration from a network through an RRC signaling. The configuration may comprise a physical channel or signal configuration across a plurality of BWPs in a cell. The physical channel or signal configuration may comprise at least one first configuration. The first configuration may be associated with a BWP identifier (ID). The apparatus may receive physical channels or signals from or to the network node according to the configuration.

### CROSS REFERENCE TO RELATED PATENT APPLICATION(S)

The present disclosure is part of a non-provisional application claiming the priority benefit of U.S. patent application Ser. No. 63/704,075, filed 7 Oct. 2024. The content of which is herein incorporated by reference in its entirety.

### TECHNICAL FIELD

The present disclosure is generally related to mobile communications and, more particularly, to bandwidth part (BWP) configuration with respect to an apparatus and a network node in mobile communications.

### BACKGROUND

Unless otherwise indicated herein, approaches described in this section are not prior art to the claims listed below and are not admitted as prior art by inclusion in this section.

Wireless communication systems may be widely deployed to provide various telecommunication services such as telephony, video, data, messaging, and broadcasts. Typical wireless communication systems may use multiple-access technologies capable of supporting communication with multiple users by sharing available system resources. Examples of such multiple-access technologies may include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

In conventional communication technologies, the bandwidth part (BWP) is applied for device energy saving by adapting the bandwidth to match traffic demand. However, when the BWP change occurs (e.g., the network node adds or modifies a primary cell and/or secondary cell), a complex BWP configuration may need to be configured to the apparatus through the radio resource control (RRC) signaling. The complex BWP configuration may comprise much of the same information for different BWPs. Therefore, heavy RRC signaling and longer BWP change delay may occur.

Accordingly, how to reduce the heavy RRC signaling for the BWP configuration in wireless communication environments becomes an important issue for the newly developed wireless communication network. Therefore, there is a need to provide proper schemes for lean BWP configuration to reduce the heavy RRC signaling.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods, and apparatus pertaining to bandwidth part (BWP) configuration with respect to an apparatus and a network node in mobile communications. It is believed that the above-described issue would be avoided or otherwise alleviated by implementing one or more of the proposed schemes described herein.

In one aspect, a method may involve an apparatus receiving a configuration from a network through a radio resource control (RRC) signaling. The configuration may comprise a physical channel or signal configuration across a plurality of BWPs in a cell. The physical channel or signal configuration may comprise at least one first configuration (e.g., BWP-specific configuration). The first configuration may be associated with a BWP identifier (ID). The method may also involve the apparatus receiving or transmitting physical channels or signals from or to the network node according to the configuration.

In another aspect, a method may involve a network node determining a configuration for a cell. The configuration may comprise a physical channel or signal configuration across a plurality of BWPs in the cell. The physical channel or signal configuration may comprise at least one first configuration (e.g., BWP-specific configuration). The first configuration may be associated with a BWP ID. The method may also involve the network node transmitting the configuration to a user equipment (UE) through an RRC signaling. The method may further involve the network node transmitting or receiving physical channels or signals to or from the UE according to the configuration.

In another aspect, an apparatus may involve a transceiver which, during operation, wirelessly communicates with at least one network node of a wireless network. The apparatus may also involve a processor communicatively coupled to the transceiver such that, during operation, the processor may receive, via the transceiver, a configuration from a network through an RRC signaling. The configuration may comprise a physical channel or signal configuration across a plurality of BWPs in a cell. The physical channel or signal configuration may comprise at least one first configuration (e.g., BWP-specific configuration). The first configuration may be associated with a BWP ID. The processor may also receive or transmit, via the transceiver, physical channels or signals from or to the network node according to the configuration.

It is noteworthy that, although description provided herein may be in the context of certain radio access technologies, networks and network topologies such as 5^{th} Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), 6th Generation (6G), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a block diagram of an example communication system in accordance with an implementation of the present disclosure.

FIG. 3 is a flowchart of an example process in accordance with an implementation of the present disclosure.

FIG. 4 is a flowchart of an example process in accordance with another implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to bandwidth part (BWP) configuration with respect to user equipment (UE) and network apparatus in mobile communications. According to the present disclosure, a number of possible solutions may be implemented separately or jointly. That is, although these possible solutions may be described below separately, two or more of these possible solutions may be implemented in one combination or another.

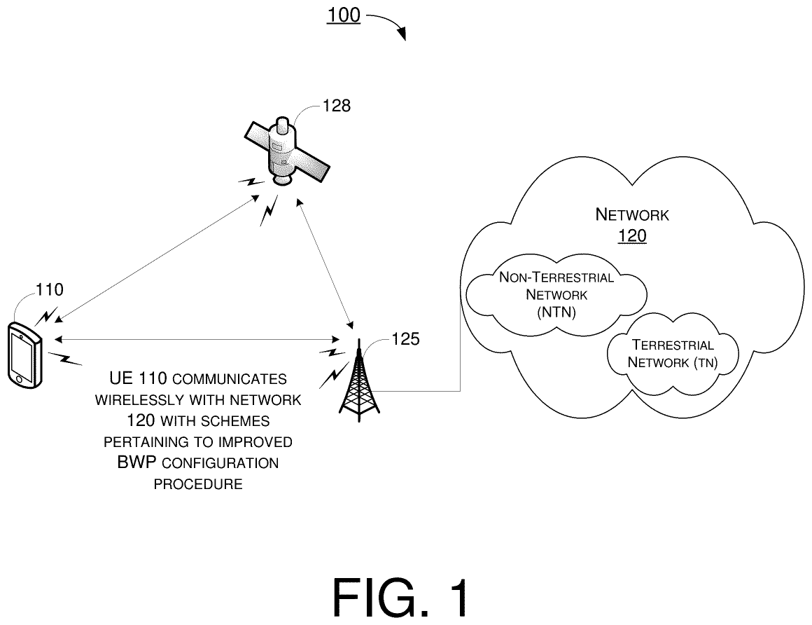

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including an NTN and a TN) via a terrestrial network node 125 (e.g., an evolved Node-B (eNB), a Next Generation Node-B (gNB), or a transmission/reception point (TRP)) and/or a non-terrestrial network node 128 (e.g., a satellite). For example, the terrestrial network node 125 and/or the non-terrestrial network node 128 may form a non-terrestrial network (NTN) serving cell for wireless communication with the UE 110. In some implementations, the UE 110 may be an IoT device such as an NB-IoT UE or an enhanced machine-type communication (eMTC) UE (e.g., a bandwidth reduced low complexity (BL) UE or a coverage enhancement (CE) UE). In such a communication environment, the UE 110, the network 120, the terrestrial network node 125, and the non-terrestrial network node 128 may implement various schemes pertaining to improving BWP configuration procedure in accordance with the present disclosure, as described below. It is noteworthy that, while the various proposed schemes may be individually or separately described below, in actual implementations, some or all of the proposed schemes may be utilized or otherwise implemented jointly. Of course, each of the proposed schemes may be utilized or otherwise implemented individually or separately.

According to the implementations of the present disclosure, an apparatus (e.g., the UE 110) may receive a configuration (e.g., a physical downlink control channel (PDCCH) configuration) from a network (e.g., the terrestrial network node 125 or the non-terrestrial network node 128) through a radio resource control (RRC) signaling (e.g., a UE-specific RRC signaling for adding or modifying a primary cell or a secondary cell). Then, the apparatus may receive or transmit physical channels or signals from or to the network node according to the configuration.

Specifically, when the network node adds or modifies a primary cell and/or a secondary cell, the apparatus may receive the configuration (or information) from the network node through dedicated RRC signaling to obtain the serving cell information. The configuration may comprise a list of carriers within the serving cell (e.g., the carrier identifier (ID) of each carrier in the serving cell, the frequency location for each carrier in the serving cell, and the bandwidth size for each carrier in the serving cell). The configuration may also comprise a numerology of the serving cell. The apparatus may determine that the same numerology is applied across all carriers and BWPs within the serving cell according to the configuration. The configuration may also comprise a list of BWPs in the serving cell. The configuration may also comprise the BWP ID for different types of BWP, e.g., an initial downlink (DL) or uplink (UL) BWP, and a network energy BWP. The apparatus may apply the BWP configurations with the same BWP ID to the above BWP types. The configuration may also comprise the configurations of the physical channel or signals. The apparatus may determine that a part of the configurations for the physical channel or signal is common across all BWPs in the serving cell according to the configuration. The configuration may also comprise the configurations of the measurement resources and reporting for the radio link measurement and the beam management. The configuration may also comprise the configurations of the rate-matching patterns. The apparatus may determine that the configurations of the rate-matching patterns are carrier-specific according to configuration, and apply the corresponding rate-matching pattern to the respective carrier.

According to an implementation of the present disclosure, the configuration from the network node may comprise a physical channel or signal configuration across a plurality of BWPs in a serving cell (e.g., a primary cell or a secondary cell).

According to an implementation of the present disclosure, the physical channel or signal configuration may comprise at least one BWP-specific configuration or BWP-relevant configuration (denoted as the first configuration in the present disclosure). Each BWP may correspond to a BWP-specific configuration. That is, each BWP-specific configuration is not common to all BWPs in the serving cell. The BWP-specific configuration may be associated with a BWP ID. In addition, the BWP-specific configuration may comprise at least one of a control resource set (CORESET) configuration (e.g., the time and frequency resource for downlink (DL) control channel monitoring), a search space configuration (e.g., the downlink control information (DCI) format for monitoring, the aggregation level and the candidate number for monitoring, the periodicity of a search space, and a monitoring occasion within a time duration for a search space), a maximum number of multi-input multi-output (MIMO) layers, a channel state information-reference signal (CSI-RS) port number, and a CSI-RS periodicity. The BWP-specific configuration may be changed through an active BWP switch. That is, the above parameters in the BWP-specific configuration may be adapted via the BWP change.

According to an implementation of the present disclosure, the physical channel or signal configuration may further comprise a non-BWP-specific configuration (denoted as the second configuration in the present disclosure) that is applied to the plurality of BWPs. That is, the non-BWP-specific configuration is common to a plurality of BWPs or all BWPs in the serving cell. The non-BWP-specific configuration may not be changed through a BWP switch. Therefore, when a BWP change occurs, the non-BWP-specific configuration may not need to be transmitted through the RRC signaling to reduce the BWP change delay. For a PDCCH configuration, the non-BWP-specific configuration may comprise at least one of a slot format indicator, a transmit power control-physical uplink shared channel (TPC-PUSCH), a TPC-physical uplink control channel (TPC-PUCCH), and a TPC-sounding reference signal (TPC-SRS).

According to an implementation of the present disclosure, the configuration from the network node may further comprise a common configuration (denoted as the third configuration in the present disclosure). The common configuration may comprise at least one of carrier information (e.g., information on one or multiple carriers), a numerology, a timing advance group (TAG) identification, and so on.

According to an implementation of the present disclosure, the configuration from the network node may further comprise a BWP configuration. The BWP configuration may comprise BWP ID information and a radio resource cluster configuration. The radio resource cluster configuration may comprise at least one of a list of radio resource clusters, an ID of each radio resource cluster, a frequency location of each radio resource cluster, a bandwidth size of each radio resource cluster, and a time division duplex (TDD) configuration of each radio resource cluster. The radio resource cluster may be a continuous radio resource in the frequency domain within a carrier. The number of supported radio resource clusters may be determined (or reported) based on the UE capability of the apparatus. The apparatus may determine a frequency resource for at least one BWP based on the radio resource cluster configuration. The apparatus may determine a duplex mode for at least one BWP based on the TDD configuration.

Under a first proposed scheme for a frequency resource configuration for a radio resource cluster, in an event that the maximum bandwidth is equal to the total bandwidth of all carriers within the serving cell, the radio resource cluster configuration may comprise a frequency location and a bandwidth size to configure the frequency resource of a radio resource cluster. Under a second proposed scheme for a frequency resource configuration for a radio resource cluster, in an event that the maximum bandwidth is equal to the total bandwidth of each carrier, the radio resource cluster configuration may comprise a carrier ID of the carrier where the radio resource cluster resides, a frequency location, and a bandwidth size to configure the frequency resource of a radio resource cluster. The bit width of the frequency location for a radio resource cluster in the first proposed scheme may be larger than the bit width of the frequency location for a radio resource cluster in the second proposed scheme. According to an implementation of the present disclosure, a resource indicator value (RIV) may be applied to determine the frequency location of a radio resource cluster and the bandwidth size of the radio resource cluster. The RIV may indicate a starting resource block (RB) and the number of RBs. The granularity of frequency resource allocation may comprise 1 RB, 1 subband, or a higher RB. The subband-based configuration may have smaller signaling, but the remainder of the RB number in a carrier divided by the RB number in a subband may not be zero.

Under a first proposed scheme for a PDCCH configuration in accordance with the present disclosure, the PDCCH configuration may comprise a common configuration (denoted as the third configuration in the present disclosure), a physical channel or signal configuration, and a BWP configuration. The common configuration may be applied to all PDCCHs in the serving cell. The physical channel or signal configuration may comprise the CORESET configuration for the BWP 1 (e.g., a list of CORESETs, a CORESET ID, a non-BWP-specific configuration, and a BWP-specific configuration for BWP 1) and the search space configuration for the BWP 1 (e.g., a list of search spaces, a search space ID, a CORESET ID, a non-BWP-specific configuration, and a BWP-specific configuration for BWP 1). In addition, the physical channel or signal configuration may also comprise the CORESET configuration for the BWP 2 (e.g., a list of CORESETs, a CORESET ID, a non-BWP-specific configuration, and a BWP-specific configuration for BWP 2) and the search space configuration for the BWP 2 (e.g., a list of search spaces, a search space ID, a CORESET ID, a non-BWP-specific configuration, and a BWP-specific configuration for BWP 2). The BWP configuration may comprise the BWP ID (e.g., 1) and BWP generic information for BWP 1, and comprise the BWP ID (e.g., 2) and BWP generic information for BWP 2.

Under a second proposed scheme for a PDCCH configuration in accordance with the present disclosure, the PDCCH configuration may comprise a common configuration (denoted as the third configuration in the present disclosure), a physical channel or signal configuration, and a BWP configuration. The common configuration may be applied to all PDCCHs in the serving cell. The physical channel or signal configuration may comprise the CORESET configuration (e.g., a list of CORESETs, a CORESET ID, and a non-BWP-specific configuration), and the search space information (e.g., a list of search spaces, a search space ID, and a non-BWP-specific configuration). The BWP configuration may comprise the BWP ID (e.g., 1) and BWP generic information for BWP 1, and comprise the BWP ID (e.g., 2) and BWP generic information for BWP 2. In addition, the BWP configuration may also comprise the CORESET configuration for the BWP 1 (e.g., a list of CORESETs, a CORESET ID, and a BWP-specific configuration for BWP 1) and the search space configuration for the BWP 1 (e.g., a list of search spaces, a search space ID, a CORESET ID, and a BWP-specific configuration for BWP 1). In addition, the BWP configuration may also comprise the CORESET configuration for the BWP 2 (e.g., a list of CORESETs, a CORESET ID, and a BWP-specific configuration for BWP 2) and the search space configuration for the BWP 2 (e.g., a list of search spaces, a search space ID, a CORESET ID, and a BWP-specific configuration for BWP 2).

Under a third proposed scheme for a PDCCH configuration in accordance with the present disclosure, the PDCCH configuration may comprise a common configuration (denoted as the third configuration in the present disclosure), a physical channel or signal configuration, and a BWP configuration. The common configuration may be applied to all PDCCHs in the serving cell. The physical channel or signal configuration may comprise the CORESET configuration (e.g., a list of CORESETs, a CORESET ID, a non-BWP-specific configuration, and a BWP-specific configuration). The BWP-specific configuration of the CORESET configuration may be associated with a list of BWP-CORESET. That is, the BWP-specific configuration may be associated with a BWP ID, and the BWP ID may be associated with a CORESET ID. The physical channel or signal configuration may also comprise the search space information (e.g., a list of search spaces, a search space ID, and a non-BWP-specific configuration). The BWP-specific configuration of the search space configuration may be associated with a list of BWP-SS (search space). That is, the BWP-specific configuration may be associated with a BWP ID, and the BWP ID may be associated with a search space (e.g., the periodicity for the BWP 1 is 1 slot, and the periodicity for the BWP 2 is 10 slots). The BWP configuration may comprise the BWP ID (e.g., 1) and BWP generic information for BWP 1, and comprise the BWP ID (e.g., 2) and BWP generic information for BWP 2.

According to an implementation of the present disclosure, in order to ensure the power saving of the apparatus, the configuration may be used to guarantee the PDCCH monitoring on a single carrier. In an example, the configuration may indicate a list of radio resource clusters within a carrier. In another example, the configuration may indicate the carrier ID and a bitmap of the frequency resource to identify the CORESET frequency location. The resource granularity may comprise an RB, a subband, or a specific granularity for CORESET, e.g., a resource element group (REG).

### Illustrative Implementations

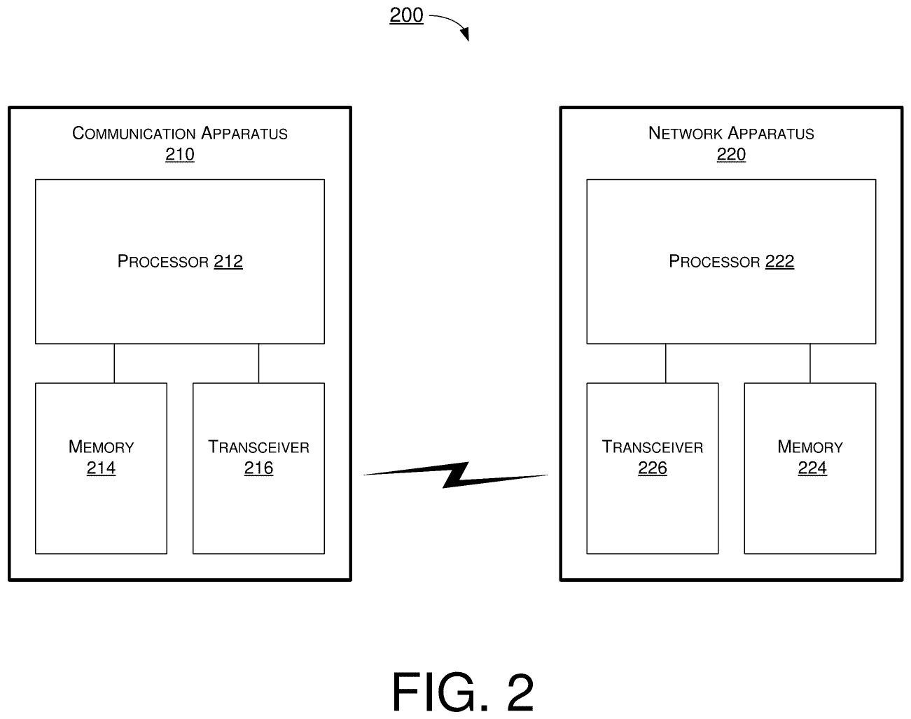

FIG. 2 illustrates an example communication system 200 having at least an example communication apparatus 210 and an example network apparatus 220 in accordance with an implementation of the present disclosure. Each of communication apparatus 210 and network apparatus 220 may perform various functions to implement schemes, techniques, processes and methods described herein pertaining to BWP configuration, including the various schemes described above with respect to various proposed designs, concepts, schemes and methods described above and with respect to user equipment and network apparatus in mobile communications, including scenarios/schemes described above as well as process 300 and process 400 described below.

Communication apparatus 210 may be a part of an electronic apparatus, which may be a UE such as a portable or mobile apparatus, a wearable apparatus, a wireless communication apparatus or a computing apparatus. For instance, communication apparatus 210 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 210 may also be a part of a machine type apparatus, which may be an IoT, NB-IoT, eMTC, IIoT UE such as an immobile or a stationary apparatus, a home apparatus, a roadside unit (RSU), a wire communication apparatus or a computing apparatus. For instance, communication apparatus 210 may be implemented in a smart thermostat, a smart fridge, a smart door lock, a wireless speaker or a home control center. Alternatively, communication apparatus 210 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 210 may include at least some of those components shown in FIG. 2 such as a processor 212, for example. Communication apparatus 210 may further include one or more other components not pertinent to the proposed schemes of the present disclosure (e.g., internal power supply, display device and/or user interface device), and, thus, such component(s) of communication apparatus 210 are neither shown in FIG. 2 nor described below in the interest of simplicity and brevity.

Network apparatus 220 may be a part of an electronic apparatus, which may be a network node such as a satellite, a BS, a small cell, a router or a gateway of an IoT network. For instance, network apparatus 220 may be implemented in a satellite or an eNB/gNB/TRP in a 4G/5G/B5G/6G, NR, IoT, NB-IoT or IIoT network. Alternatively, network apparatus 220 may be implemented in the form of one or more IC chips such as, for example and without limitation, one or more single-core processors, one or more multi-core processors, or one or more RISC or CISC processors. Network apparatus 220 may include at least some of those components shown in FIG. 2 such as a processor 222, for example. Network apparatus 220 may further include one or more other components not pertinent to the proposed scheme of the present disclosure (e.g., internal power supply, display device and/or user interface device), and, thus, such component(s) of network apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks, including the proposed BWP configuration, in a device (e.g., as represented by communication apparatus 210) and a network node (e.g., as represented by network apparatus 220) in accordance with various implementations of the present disclosure.

In some implementations, communication apparatus 210 may also include a transceiver 216 coupled to processor 212 and capable of wirelessly transmitting and receiving data. In some implementations, transceiver 216 may be capable of wirelessly communicating with different types of UEs and/or wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, network apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, communication apparatus 210 may further include a memory 214 coupled to processor 212 and capable of being accessed by processor 212 and storing data therein. In some implementations, network apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 210 and network apparatus 220 may be a communication entity capable of communicating with each other using various proposed schemes in accordance with the present disclosure. For illustrative purposes and without limitation, descriptions of capabilities of communication apparatus 210, as a UE, and network apparatus 220, as a network node (e.g., TRP), are provided below with process 300 and process 400.

### Illustrative Processes

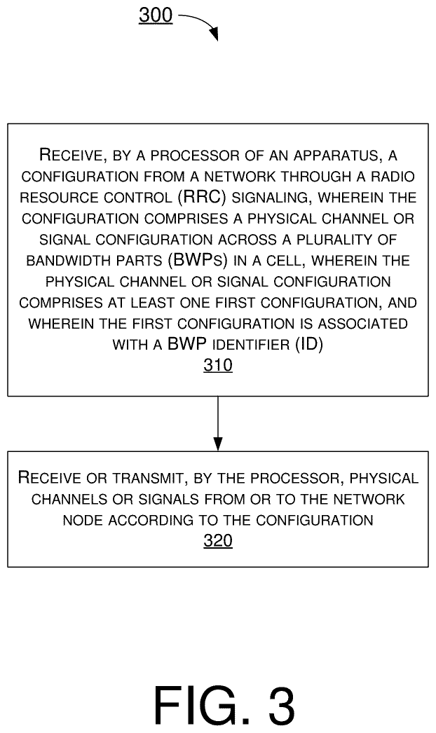

FIG. 3 illustrates an example process 300 in accordance with an implementation of the present disclosure. Process 300 may be an example implementation of above scenarios/schemes, whether partially or completely, with respect to BWP configuration with the present disclosure. Process 300 may represent an aspect of implementation of features of communication apparatus 210. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks of process 300 may be executed in the order shown in FIG. 3 or, alternatively, in a different order. Process 300 may be implemented by communication apparatus 210. Solely for illustrative purposes and without limitation, process 300 is described below in the context of communication apparatus 210. Process 300 may begin at block 310.

At block 310, process 300 may involve processor 212 of communication apparatus 210 receiving, via transceiver 216, a configuration from a network through an RRC signaling. The configuration may comprise a physical channel or signal configuration across a plurality of BWPs in a cell. The physical channel or signal configuration may comprise at least one first configuration (e.g., BWP-specific configuration). The first configuration may be associated with a BWP ID. Process 300 may proceed from block 310 to block 320.

At block 320, process 300 may involve processor 212 receiving or transmitting, via transceiver 216, physical channels or signals from or to the network node according to the configuration.

In some implementations, the first configuration may comprise at least one of a CORESET configuration, a search space configuration, a maximum number of MIMO layers, a CSI-RS port number, and a CSI-RS periodicity.

In some implementations, the physical channel or signal configuration may further comprise a second configuration (e.g., non-BWP-specific) which is applied to the plurality of BWPs.

In some implementations, the second configuration may comprise at least one of a slot format indicator, a TPC-PUSCH, a TPC-PUCCH, and a TPC-SRS.

In some implementations, the configuration may further comprise a third configuration (e.g., common configuration), and wherein the third configuration comprises at least one of a carrier information, a numerology, and a TAG identification.

In some implementations, the configuration may further comprise a BWP configuration. The BWP configuration may comprise a BWP ID information and a radio resource cluster configuration.

In some implementations, the radio resource cluster configuration may comprise at least one of a list of radio resource clusters, an ID of each radio resource cluster, a frequency location of each radio resource cluster, a bandwidth size of each radio resource cluster, and a TDD configuration of each radio resource cluster.

In some implementations, a frequency resource for at least one BWP may be determined based on the radio resource cluster configuration.

In some implementations, a duplex mode for at least one BWP may be determined based on the TDD configuration.

In some implementations, an RIV may be applied to determine the frequency location and the bandwidth size of one radio resource cluster.

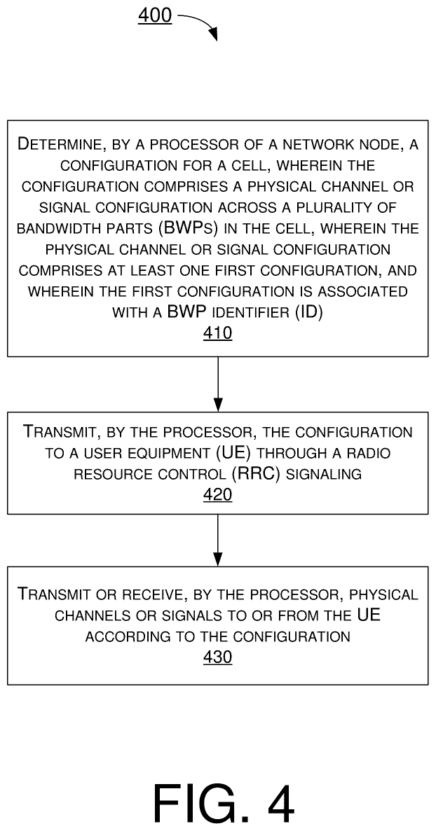

FIG. 4 illustrates an example process 400 in accordance with another implementation of the present disclosure. Process 400 may be an example implementation of above scenarios/schemes, whether partially or completely, with respect to BWP configuration with the present disclosure. Process 400 may represent an aspect of implementation of features of network apparatus 220. Process 400 may include one or more operations, actions, or functions as illustrated by one or more of blocks 410, 420 and 430. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by network apparatus 220. Solely for illustrative purposes and without limitation, process 400 is described below in the context of network apparatus 220. Process 400 may begin at block 410.

At block 410, process 400 may involve processor 222 of network apparatus 220 determining a configuration for a cell. The configuration may comprise a physical channel or signal configuration across a plurality of BWPs in the cell. The physical channel or signal configuration may comprise at least one first configuration (e.g., BWP-specific configuration). The first configuration may be associated with a BWP ID. Process 400 may proceed from block 410 to block 420.

At block 420, process 400 may involve processor 222 transmitting, via transceiver 226, the configuration to a UE through an RRC signaling. Process 400 may proceed from block 420 to block 430.

At block 430, process 400 may involve processor 222 transmitting or receiving, via transceiver 226, physical channels or signals to or from the UE according to the configuration.

In some implementations, the first configuration comprises at least one of a CORESET configuration, a search space configuration, a maximum number of MIMO layers, a CSI-RS port number, and a CSI-RS periodicity.

In some implementations, the physical channel or signal configuration may further comprise a second configuration (e.g., non-BWP-specific configuration) which is applied to the plurality of BWPs.

In some implementations, the second configuration may comprise at least one of a slot format indicator, a TPC-PUSCH, a TPC-PUCCH, and a TPC-SRS.

In some implementations, the configuration may further comprise a third configuration (e.g., common configuration), and wherein the third configuration comprises at least one of a carrier information, a numerology, and a TAG identification.

In some implementations, the configuration may further comprise a BWP configuration. The BWP configuration may comprise a BWP ID information and a radio resource cluster configuration.

In some implementations, the radio resource cluster configuration may comprise at least one of a list of radio resource clusters, an ID of each radio resource cluster, a frequency location of each radio resource cluster, a bandwidth size of each radio resource cluster, and a TDD configuration of each radio resource cluster.

In some implementations, a frequency resource for at least one BWP may be determined based on the radio resource cluster configuration. A duplex mode for at least one BWP may be determined based on the TDD configuration. An RIV may be applied to configure the frequency location and the bandwidth size of one radio resource cluster.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more; ” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a configuration from a network through a radio resource control (RRC) signaling, wherein the configuration comprises a physical channel or signal configuration across a plurality of bandwidth parts (BWPs) in a cell, wherein the physical channel or signal configuration comprises at least one first configuration, and wherein the first configuration is associated with a BWP identifier (ID); and
receiving or transmitting, by the processor, physical channels or signals from or to the network node according to the configuration.

2. The method of claim 1, wherein the first configuration comprises at least one of a control resource set (CORESET) configuration, a search space configuration, a maximum number of multi-input multi-output (MIMO) layers, a channel state information-reference signal (CSI-RS) port number, and a CSI-RS periodicity.

3. The method of claim 1, wherein the physical channel or signal configuration further comprises a second configuration which is applied to the plurality of BWPs.

4. The method of claim 3, wherein the second configuration comprises at least one of a slot format indicator, a transmit power control-physical uplink shared channel (TPC-PUSCH), a TPC-physical uplink control channel (TPC-PUCCH), and a TPC-sounding reference signal (TPC-SRS).

5. The method of claim 1, wherein the configuration further comprises a third configuration, and wherein the third configuration comprises at least one of a carrier information, a numerology, and a timing advance group (TAG) identification.

6. The method of claim 1, wherein the configuration further comprises a BWP configuration, and wherein the BWP configuration comprises a BWP ID information and a radio resource cluster configuration.

7. The method of claim 6, wherein the radio resource cluster configuration comprises at least one of a list of radio resource clusters, an ID of each radio resource cluster, a frequency location of each radio resource cluster, a bandwidth size of each radio resource cluster, and a time division duplex (TDD) configuration of each radio resource cluster.

8. The method of claim 7, wherein a frequency resource for at least one BWP is determined based on the radio resource cluster configuration.

9. The method of claim 7, wherein a duplex mode for at least one BWP is determined based on the TDD configuration.

10. The method of claim 7, wherein a resource indicator value (RIV) is applied to determine the frequency location and the bandwidth size of one radio resource cluster.

11. A method, comprising:
determining, by a processor of a network node, a configuration for a cell, wherein the configuration comprises a physical channel or signal configuration across a plurality of bandwidth parts (BWPs) in the cell, wherein the physical channel or signal configuration comprises at least one first configuration, and wherein the first configuration is associated with a BWP identifier (ID);
transmitting, by the processor, the configuration to a user equipment (UE) through a radio resource control (RRC) signaling; and
transmitting or receiving, by the processor, physical channels or signals to or from the UE according to the configuration.

12. The method of claim 11, wherein the first configuration comprises at least one of a control resource set (CORESET) configuration, a search space configuration, a maximum number of multi-input multi-output (MIMO) layers, a channel state information-reference signal (CSI-RS) port number, and a CSI-RS periodicity.

13. The method of claim 11, wherein the physical channel or signal configuration further comprises a second configuration which is applied to the plurality of BWPs.

14. The method of claim 13, wherein the second configuration comprises at least one of a slot format indicator, a transmit power control-physical uplink shared channel (TPC-PUSCH), a TPC-physical uplink control channel (TPC-PUCCH), and a TPC-sounding reference signal (TPC-SRS).

15. The method of claim 11, wherein the configuration further comprises a third configuration, and wherein the third configuration comprises at least one of a carrier information, a numerology, and a timing advance group (TAG) identification.

16. The method of claim 11, wherein the configuration further comprises a BWP configuration, and wherein the BWP configuration comprises a BWP ID information and a radio resource cluster configuration.

17. The method of claim 16, wherein the radio resource cluster configuration comprises at least one of a list of radio resource clusters, an ID of each radio resource cluster, a frequency location of each radio resource cluster, a bandwidth size of each radio resource cluster, and a time division duplex (TDD) configuration of each radio resource cluster.

18. The method of claim 17, wherein a frequency resource for at least one BWP is determined based on the radio resource cluster configuration, wherein a duplex mode for at least one BWP is determined based on the TDD configuration, and wherein a resource indicator value (RIV) is applied to configure the frequency location and the bandwidth size of one radio resource cluster.

19. An apparatus, comprising:
a transceiver which, during operation, wirelessly communicates with at least one network node of a network; and
a processor communicatively coupled to the transceiver such that, during operation, the processor performs operations comprising:
receiving, via the transceiver, a configuration from the network through a radio resource control (RRC) signaling, wherein the configuration comprises a physical channel or signal configuration across a plurality of bandwidth parts (BWPs) in a cell, wherein the physical channel or signal configuration comprises at least one first configuration, and wherein the first configuration is associated with a BWP identifier (ID); and
receiving or transmitting, via the transceiver, physical channels or signals from or to the network node according to the configuration.

20. The apparatus of claim 19, wherein the configuration further comprises a BWP configuration, and wherein the BWP configuration comprises a BWP ID information and a radio resource cluster configuration.
